(19) United States
(12) Patent Application Publication
(10) Pub. No.: US 2004/0034705 A1
(43) Pub. Date: Feb. 19, 2004

(54) Connecting devices in a data network

(76) Inventor: Mihai Focsaneanu, Ottawa (CA)

Correspondence Address: Mihai FOCSANEANU, 79 Charing Rd., Ottawa, ON, K2G 4C5, CA

(21) Appl. No.: 10/216,761

(22) Filed: Aug. 13, 2002

(51) Int. Cl. G06F 15/173

(52) U.S. Cl. 709/225; 709/220

(57) ABSTRACT

An address discovery scheme that enables a user connected to a data network to obtain the current address of any other user connected to the network, including users at fixed location and mobile users. This new addressing discovery process is supported by new network capabilities built into the users' networked devices and into new network elements, the address servers. Working together with the new users' networked devices, the address servers enable the establishment and maintenance of temporary associations between users and their network addresses. This information is accessible to other users of the network; however, the individual users have the ability to control its dissemination.

### FIELD OF THE INVENTION

The present invention relates to the data communication networks and more particularly to the discovery of the network address of devices communicating over a data network.

### BACKGROUND OF THE INVENTION

The telecommunications revolution of the twentieth century provided initially universal voice connectivity among all users. A true peer-to-peer communications model, the modern telephony network allows any individual user to connect directly to any other user and exchange information. To implement this universal connectivity concept, the Public Switched Telephony Network (PSTN) uses a numbering scheme to enable locating and connecting individual voice communicating devices, i.e. the telephones. The user devices connect to the PSTN via dedicated lines, where each line has a unique telephone number. The association between a telephone line and the telephone number is quasi-permanent and therefore, one can always reach another individual's telephone by dialing the permanent number assigned to that individual's phone line.

The advent of computers and the Internet explosion of the last decade opened up the door towards a multitude of new applications while introducing significant new technological challenges. The use of multimedia for exchanging information allowed the development and the deployment of a plethora of new services that were not possible in a voice-dominated PSTN. The Internet, also referred to as IP (internet protocol), built originally for academics to serve a few thousand machines, became a network environment with millions of users.

The Internet is a communications network that connects networking devices (i.e. user terminals), with the purpose of enabling a networking device to send/receive information to/from any other device connected to Internet. To enable the routing of information from the sender to the intended destination, the Internet uses an addressing scheme that uniquely identifies every device active on the network. Recognizing that with the explosion of the number of devices connected to the network, the available network addresses become a scarce and costly resource, new methods were introduced to manage and optimize the use of the address pool resource. One widely used method is the assignment of the address to an active device for a predetermined length of time. Once the time has expired, or the device has been disconnected, the assigned address is returned to the common pool and becomes available for re-assignment to another device requesting network access.

Although the Internet was designed with a peer-to-peer concept in mind, most of the current service applications use a client/server model. Today, the IP network architecture is highly centralized, with relatively few large servers. The many clients using the network connect to these servers to navigate the Internet. However, a client/server model is appropriate for some services only, such as browsing through large information repositories, downloading information, or communicating, in non-real time, with other clients of the IP network (e-mail). For other services, such as work collaboration and information exchange between users, a peer-to-peer model is more advantageous.

For example, a potential user of messenger services has to subscribe to services provided by e.g. AOL Instant Messenger, Yahoo Messenger, ICQ, or MSN Messenger. The use of this service is restricted to the subscribers in the same service provider domain. Subscribers to different service providers cannot exchange messages among themselves. One user can subscribe to multiple service providers and, by initiating separate sessions with each one of them, can exchange messages with individual subscribers of each other service provider. For example, a subscriber to both services, AOL Instant Messenger and ICQ, can initiate two simultaneous sessions with the AOL Instant Messenger server and with the ICQ server. Off course, this user has to use two different messenger applications. Clearly, this is not a user-friendly environment.

A peer-to-peer approach, similar to that in the telephone network, will allow any user connected to the IP network to directly reach any other user(s) on the network for the purpose of exchanging information, without the need of centralized servers. Any device connected to the network would be able to establish a peer-to-peer communications link with every other device connected to the network. The applications providing the capability to exchange information between users on a peer-to-peer basis already reside on the individual personal computers. Dramatic evolution of the computational power of the PCs allows equipping these devices with further applications as they emerge.

However, implementation of a peer-to-peer service model in today's IP network introduces several technological challenges. The article entitled “Peer-to-peer Models Through the History of the Internet” by Nelson, Minar, and Hedlund (0-596-00110-X) highlights some of the technical difficulties encountered by engineers designing peer-to-peer systems. The paper acknowledges that one of the key difficulties in implementing a peer-to-peer service architecture is the widespread practice of assigning dynamic network addresses to devices connected to the network. As was previously discussed, the Internet Access Provider (AP) has a pool of network addresses for its subscribers, which addresses are dynamically allocated to each connection. Since this address assignment is temporary, it is reasonable to assume that a user may receive a different address each time he connects to the network. A mobile user, accessing the network from different locations, potentially using different devices, will have different network addresses each time it accesses the network.

On the other hand, in a peer-to-peer decentralized network architecture, a person originating a connection U1 knows the user name of the person he wishes to contact U2, but does not know the network address of that person networking device. Moreover, a person trying to set-up a connection but failing to do so, does not receive any indication of the cause of the failure, i.e. if the failure is due to an incorrect address, to the destination device not being connected to the network, or to other causes.

The dynamic address allocation does not create a major hurdle for the most popular application such as searches, e-mail, or data retrieval, that use a centralized architecture. However, it becomes a barrier for development and dissemination of new, more complex services, such as messaging, conferences, chat, etc., that use a peer-to-peer architecture. There is a need to eliminate these barriers to ensure a better and more flexible exploitation of the benefits of the Internet.

U.S. Pat. No. 6,226,684 B1, (Sung et al.), describes a messaging scheme in a client/server architecture. U.S. Pat. No. 5,812,795, (Horovitz et al.), describes a peer-to-peer communications scheme in which the sender searches the internal directory to find the appropriate address for the recipient of the message. In these examples, the systems assume prior knowledge of the message destination address. The current dynamic address allocation scheme creates an insurmountable hurdle for the implementation of these systems.

### SUMMARY OF THE INVENTION

It is an object of this invention to create a network architecture that enables unrestricted use of peer-to-peer applications. Any user can contact any other user (or users), can establish a direct connection with another user of choice based on the network address of that user's device, and set-up a session in a true peer-to-peer manner. This invention is applicable to both fixed-location users and mobile users.

To achieve these objectives, this invention is introducing a new address discovery scheme enabling a user connected to the network to obtain the current address information of any other user connected to the network, including both users at fixed location and mobile users.

This new addressing discovery process is supported by new network capabilities built into the users' networked devices and into new network elements, the address servers. Working together with the new users' networked devices, the address servers enable the establishment and maintenance of temporary associations between users and their network addresses. This information is accessible to other users of the network; however, the individual users have the ability to control its dissemination.

Briefly stated, the invention provides a method of address discovery in a data network connecting a plurality of networked devices, comprising: providing at least a first and a second address servers for serving a first and a second networked device respectively; declaring network presence by the first networked device upon connection to the first address server, by transmitting to the first address server a first address data.

In accordance with another aspect of the invention, there is provided a method for establishing a direct communication between a first networked device and a second network device over a data network, each having a compatible peer-to-peer application, comprising: providing a first address server for updating a first address data whenever the first networked device connects to the network; providing a second address server for updating a second address data whenever the second networked device connects to the network; and connecting the first address server with the second address server for enabling transfer of the second address data from the second address server to the first address server on request.

In another aspect, the invention provides a method of direct communication over a data network between a first networked device having a first current address Add1 and a second networked device having a second current address Add2, comprising: (a) providing a first address server with a first address data for the first networked device and providing a second address server with a second address data for the second networked device; (b) at the first networked device, requesting from the first address server the Add2; (c) at the first address server, obtaining the Add2 from the second address server and transmitting same to the first networked device; and (d) establishing a direct communication between the first and the second device based on the first and second current address data.

Still further aspect, the invention is concerned with an address server for use in a data network, comprising: an address discovery unit for determining a temporary network address; a network interface for providing an address request signal to the address discovery unit and transmitting the network address from the address discovery unit; an address server interface for broadcasting a query signal and receiving a query response signal; and a processing unit for controlling the operation of the address discovery unit, the network interface and the address server interface.

According to still another aspect, the invention is also directed to a networked device having a temporary network address Add1, the networked device comprising: an address query unit for declaring network presence and for requesting a queried network address Add2 of a queried networked device; an interface for transmitting an address request signal and receiving the Add2; a network application for enabling the networked device to provide a certain service; an interface for enabling the network application to communicate directly with a peer network application based on the Add1 and Add2; and a processing unit for controlling the operation of the address query unit, the network interfaces and the network application.

The main advantage of this invention is the universal reach, allowing one user to establish connections and exchange information with virtually every other user connected to the network. In addition, the invention enables peer-to-peer type applications to reside only on the users' devices; it creates a true distributed service architecture, without the need for centralized, dedicated servers running service applications.

Still further, the invention eliminates the need for users to subscribe to service providers server-based offerings.

### BRIEF DESCRIPTION OF THE DRAWINGS

FIG. 1 shows the current data network architecture illustrating the conventional address allocation scheme;

FIG. 2A shows the current data network architecture illustrating two service providers' domains;

FIG. 2B shows how a service is activated and used in a client-server environment as in FIG. 2A;

FIG. 3 shows the peer-to-peer service architecture concept;

FIG. 4A shows an example of a network architecture according to the invention;

FIG. 4B shows a high-level block diagram of the networked device and address server according to the invention;

FIG. 5 shows an embodiment of the protocol used to obtain the address information of a networked device in one instance;

FIG. 6 shows the protocol used to obtain the address information of a device in another instance;

FIG. 7 shows the protocol used to obtain the address information of a network device in still another instance;

FIG. 8 shows the protocol used to obtain the address information of a plurality of networked devices in still another instance;

FIGS. 9A to 9E show various examples of signaling message formats supporting this invention. Thus, FIG. 9A shows a network presence declaring signal for log-on an address server, FIG. 9B shows an address discovery request or address query signal, FIG. 9C illustrates a query response signal sent by an address server in response to an address query, FIG. 9D shows a multiple address request signal for a n-way direct communication, and FIG. 9E shows a multiple query response signal sent by an address server in response to a multiple address request.

### DETAILED DESCRIPTION

The following terminology is used throughout this specification:

User is an individual employing a networked device to send/receive electronic information (particularly over the Internet). It is referred to here with Un, where n=1,2 . . . N.

User identification, User ID or User name are unique designations associated with a user, referred with UIDn, where n=1,2 . . . N.

Access provider is an entity that offers access to the Internet in exchange for a subscription. It is generically referred to with APn, where n=1,2 . . . N.

Service provider is an entity that offers various network applications, such as e-mail, search engines, etc in exchange for a subscription. It is generically referred to with SPn, where n=1,2 . . . N.

Subscriber is a user that acquired the right to certain service(s) offered by a service provider It is generically referred to with Sn, where n=1,2 . . . N.

Service application is a software program that enables a certain service. Thus, a service provider may offer to its subscribers server-based applications for e-mail services, messaging services, etc. Other service applications such as document sharing, conferencing, etc may use a server-less, peer-to-peer approach.

Networked device is an apparatus, in general a personal computer, that connects a user to a network to send/receive electronic information.

Network address, UserAddress or Address are unique designations that follow the specifications of the network protocol and enable the users to identify to the network elements, the source and the destination of the electronic information, such as IP addresses. It is referred to here with Addn, where n=1,2 . . . N.

Logical communications channel designates network's capability of routing information from a source networked device to the destination networked device based on the destination network address.

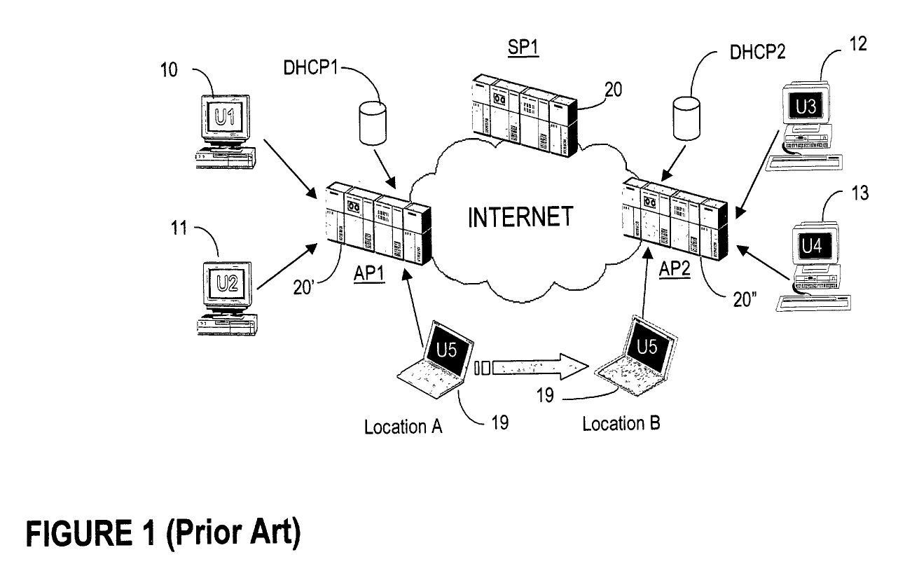

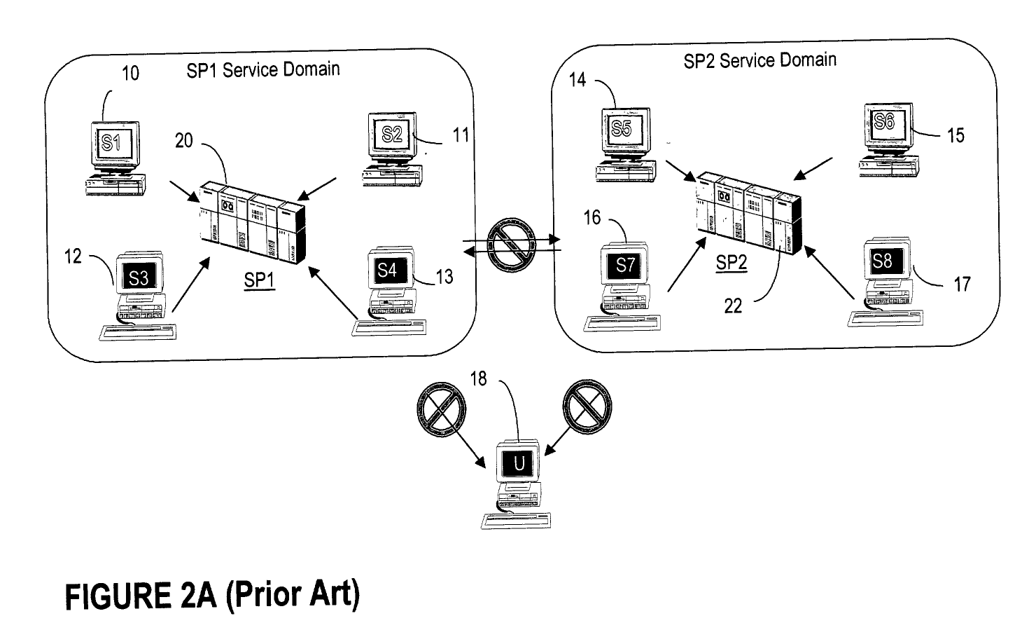

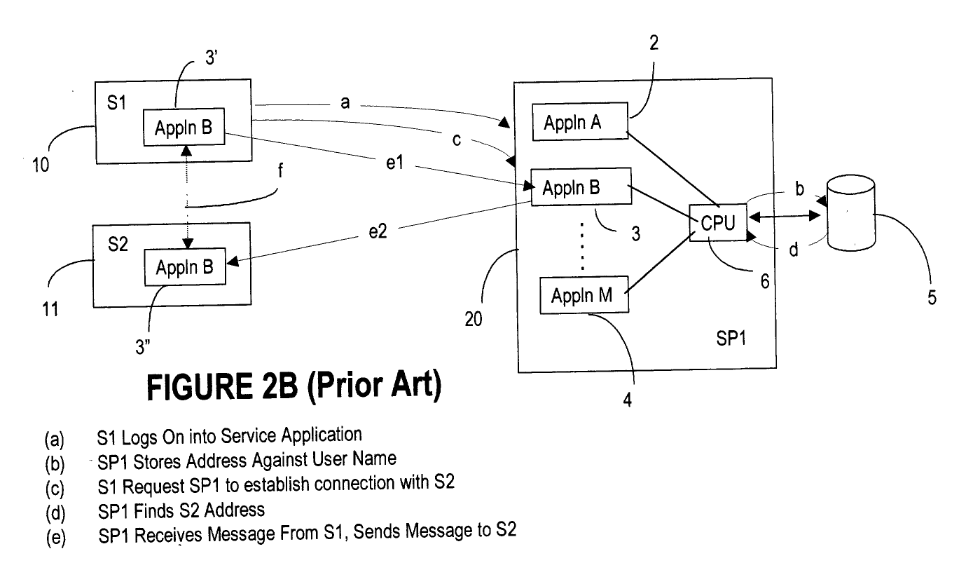

FIGS. 1 and 2A-2B illustrate how services are provided over Internet currently. Thus, FIG. 1 illustrates the most common way of connecting individual devices to a data network. The network connectivity is provided by Internet Access Providers (AP), as shown at AP1 and AP2 through the access servers 20′ and 20″. It is to be noted that AP1 and AP2 may be in the same service provider domain SP1, or not. Devices 10, 11, 12 and 13 are generally personal computers (PC's) or laptops, connected to Internet over telephone lines, cable, wireless, etc. Individual users U1 to U4 establish direct connections to the respective access server 20′, 20″. Following a successful “log-in” the AP assigns a temporary network address to the user's device. The management of the network address pool is provided by the Dynamic Host Configuration Protocol (DHCP) functionality, as shown by DHCP1 and DHCP2. To become an Internet user, U1-U4 must subscribe to an access provider AP1, AP2, which offers access services for a monthly subscription fee that specifies in general a maximum connection time. Now, to effectively connect to Internet, device 10 receives a temporary Internet address whenever it logs-in. Upon the expiration of the address lease contract, or upon the user disconnecting his device from the network, the assigned address is returned to the address pool and is available to be re-assigned to another user requesting network connectivity.

Networked device 10 will most probably receive another address for any subsequent connection. Using the same address assigning scheme, networking device 19 of a mobile user U5, will obtain a network address from the Access Provider AP1 at Location A, and will obtain a different address at location B from Access Provider AP2. Note that the network access scheme discussed above and illustrated in FIG. 1 is universal. To summarize, the address allocation scheme on Internet is connection-oriented rather than user-oriented.

Therefore, the details of connecting to the network and obtaining a network address are omitted from this specification. For simplicity and clarity, it is assumed that all devices that do not have permanent network addresses, obtain their respective network addresses following the scheme presented above.

Furthermore, although the Internet was designed with a peer-to-peer information exchange model in mind, most of the current service application implementations use a client /server model. In a client/server service model, the service providers deploy one or more servers that are designed to enable a specific service for a community of subscribers. Therefore, the service providers use a network architecture that requires a user to subscribe to the service offered and imposes a specific procedure to access and use the service, as shown in FIGS. 2A and 2B. For services designed to enable exchanges of information among user groups, this client/server model imposes severe restrictions.

FIG. 2A illustrates a conventional client/server service architecture and highlights its limitations. Let's say that a service provider SP1 offers a messaging service through a server 20. Only subscribers S1, S2, S3 and S4 subscribing to the service provided by SPI can connect their devices 10, 11, 12 and 13 to the server 20 to use this service. Device 18 cannot connect to server 20, since user U is not in the service domain of SP1 (i.e. not a subscriber to the services provided by SP1). In other words, subscribers S1-S4 cannot reach user U to send/receive messages.

Furthermore, if another service provider SP2 offers a messaging service through another server 22, only subscribers S5-S8 subscribing to the service provided by the SP2 can connect their networked devices 14, 15, 16 and 17 to use this service. Although all subscribers subscribe to the same type of service, subscribers S1-S4 cannot use the service to reach subscribers S5-S8 and send/receive messages. User U, not being a subscriber to either SP1 or SP2, cannot connect to either server 20, or server 22, so that subscribers S1 through S8 cannot reach user U to send/receive messages.

The example provided in FIG. 2B depicts diagrammatically how subscriber S1 shown in FIG. 2A sends a message to a subscriber S2 both being in the SP1 domain. Let's assume that SP1 offers a plurality of services, as shown by applications 2, 3 and 4 (ApplnA-ApplnM). Let's also assume that application 3 offers a messaging service and S1 and S2 are two subscribers to this service. Both subscribers need to have the service capability, so that S1 and S2 have to subscribe to the service provided by the service provider SP1, as shown by the client applications 3′ and 3″ on the networked devices 10 and 11 of the respective S1 and S2. The user downloads and installs on its computer the local service software that, in conjunction with the managing service application running on the central server, enables the user to activate and use the service.

The actual procedure enabling the user to use the service comprises several steps, denoted with a-e on FIG. 2B. To activate a certain service, such as application 3 in this example, subscriber S1 has to contact the central server 20 and log-on, step a. The central processing unit 6 of server 20 adds the user's address information into its database 5, step b. Independently from subscriber S1, another subscriber S2 requests activation of service 3 following the same process. The user S1 then requests server 20 to enable communication with user S2, step c. SP1 searches its database 5 for the address of users S2, and finds the temporary network address of SP2, step d. Once the address of S2 is found, S1 sends the message for S2, to the server SP1, and server SP1 forwards the message to subscriber S2, step e1, e2.

If for example the application 3 is a messenger service, server 20 actively participates to connect subscriber S1 to subscriber S2; in other words, the subscribers do not communicate directly. Using the same approach as a mail server, the messenger server 3 receives the message from the originator S1 (see e1) and forwards it to the destination S2 in quasi real time (see e2). The originator of the message S1 does not need to know the network address of the destination user. As discussed earlier, this mode of operation introduces restrictions and limitations in the use of some services. For example, user 18 in FIG. 2A, which did not subscribe to the service 3 offered by the service provider SP1 cannot exchange messages with the other subscribers S1-S4.

This invention introduces a new approach that enables the users connected to a network to exchange information in a peer-to-peer model, as shown by arrow f on FIG. 2B, which connects directly S1 with S2. It is evident that a direct connection f simplifies the communication between S1 and S2, as it circumvents the server 20. The peer-to-peer approach provides significant advantages to users requiring services designed to enable exchange of information among relatively small groups.

Such an arrangement will result in a less expensive service for both users S1 and S2, as they do not need to use the service 3 for mediating the users' connectivity and the users' exchange of information. Still further, eliminating the applications server 3 makes the service more robust, more flexible and more secure.

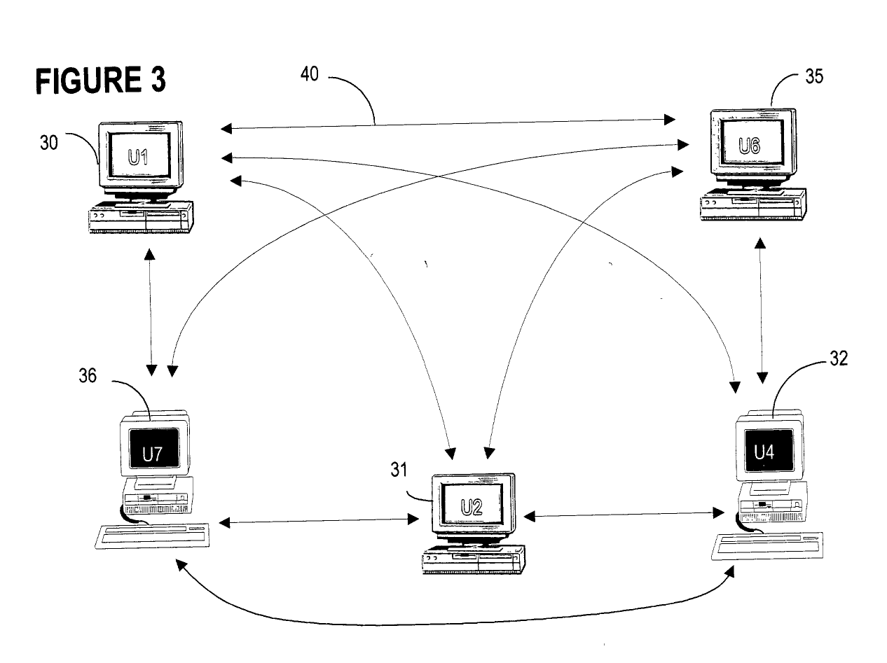

FIG. 3 illustrates a peer-to-peer approach, similar to that in the telephone network. In this approach, any networked device 30, 35, 36 and 32 connected to the network can establish a direct, peer-to-peer communications link with every other device connected to the network, as shown by the arrows between all other users U1, U6, U7 and U4. Arrow 40 illustrates for example a connection between devices 30 and 35 (i.e. U1 and U6).

As indicated above, the most important challenge posed by the peer-to-peer implementation in todays data networking environment is address management/discovery, and in particular the volatility of the relationship between the user name and the network address. This invention attempts to solve the address discovery problem by providing the network with means for detecting the temporary association of users and network addresses, while making this information easily available to all network users.

In one embodiment, this invention introduces a new network element, the address server. The address server is an apparatus that performs specific operations as described next by the various embodiments of the invention.

Most importantly, the address server according to the invention stores the user identification and when the user connects to the network, obtains the network address of the user's networked device and creates a record associating the user with the network address. A plurality of address servers are linked through the communications network enabling them to receive a query from a user requesting network address information of other users connected to the network, to relay the query to other address servers and to respond to the original query when the network address information sought is available within their database.

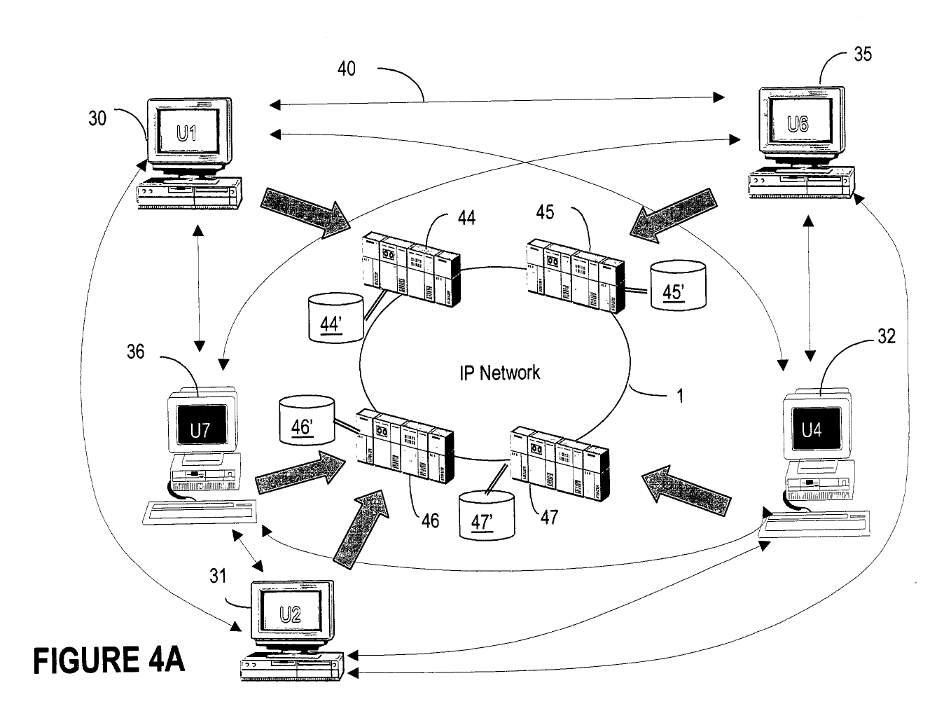

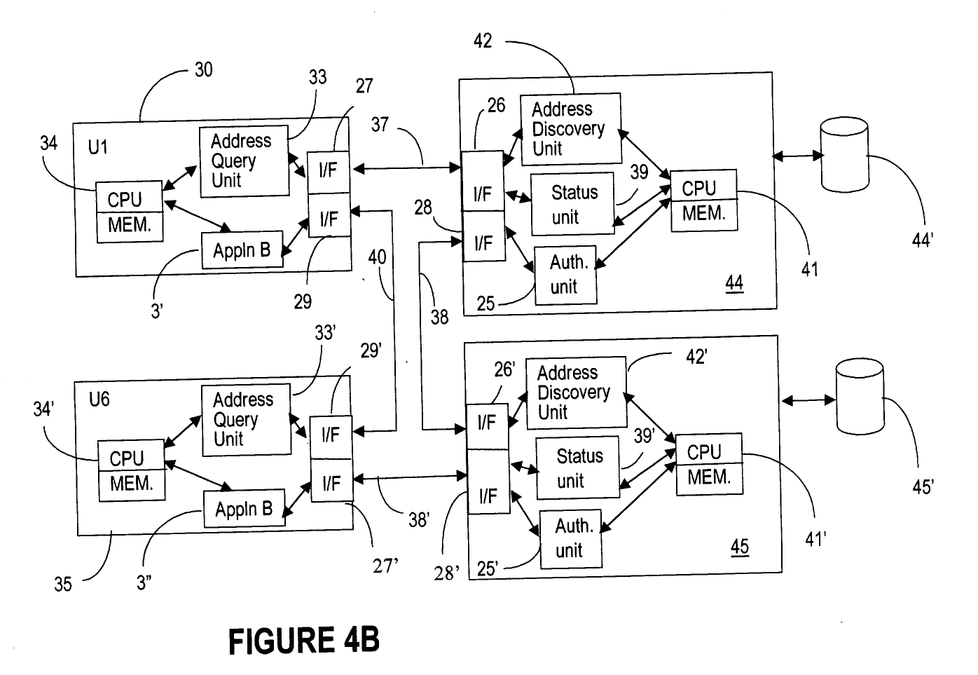

FIG. 4A shows the new network architecture according to the invention, enabling the implementation of a peer-to-peer service model. The term user replaces the term subscriber used in connection with FIGS. 2A and 2B (see above definitions), since the users in this case do not need to subscribe to service application 3 or other similar applications. Thus, users of networked devices 30, 35, 32 and 36 correspond to the subscribers S1, S4, S6, S7 in FIG. 2A, and are similarly denoted with U1, U4, U6 and U7. These users were selected to indicate that according to the invention, the subscription to a service provider is not required. Although, U1 and U4 may be subscribers to SP1 as before, and U6 and U7 may be subscribers to SP2 for services such as searches, e-mail, etc these users do not need to additionally subscribe to the service application 3 of FIG. 2B.

In the example network of FIG. 4A, any device connected to the network can establish a peer-to-peer communications link with every other device connected to the network, as shown by arrow 40 for the connection between users U1 and U6, and by the unmarked arrows between all other users. Any user, through its networked device can connect to any other user's networked device for the purpose of exchanging information, which exchange is governed by specific service implementations. As previously mentioned, this concept follows on the initial intent of the creators of Internet.

For example, user U1 can directly communicate not only with users U2 and U4 (subscriber S1 could communicate with S2 and S4 in FIG. 2A, but only indirectly, over server 20), it can also directly communicate with subscribers U6 and U7, which was not possible in the architecture of FIG. 2A.

In the architecture of FIG. 4A, a network of four address servers 44, 45, 46 and 47 supports the address discovery process required by users U1, U2, U4, U6 and U7. For example, the network address information for user U1 is stored in the storage (database) 44′ associated with the address server 44. Similarly, the network address information for users U6 and U4 is stored respectively in the databases 45′ and 47′ of the respective address servers 45 and 47, while the address server 46 stores the network address information for the networked devices U2 and U7.

FIG. 4B shows a high-level block diagram of the networked device and address server according to the invention.

The implementation of an address server may take various forms. An address server such as 44 can be built on a dedicated computing engine that includes a central processing unit CPU and memory 41 and an address discovery unit 42. The address server is also provided with network communications capabilities, shown as the interface 26 to allow communications with networked devices, such as 30 in this example, and interface 28 to allow communication with other address servers, such as server 45 in this example. Thus, the address server 44 communicates with the networked device 30 over logical communication channel 37 and with the peer address server 45 over logical communication channel 38. The databases 44′, 45′ are shown separately from the respective address server to specifically illustrate that all units of the respective blocks 44, 45 have access to memory space.

Address discovery unit 42 determines and transmits the temporary network address of the device in response to a query, and also interprets and transmits adequate messages to the networked device regarding the status of the devices it wishes to communicate with. It may also store, process and retrieve user profile messages.

An authentication unit 25, 25′ enables password based log-on for the clients of the respective address server. It is to be noted that a better term than “log-on” is, in this case, “declaring network presence” since the user is already connected to the Internet. However, the term “log-on” is still used in the following for simplicity. An address server can be also provided with a status unit 39, 39′ that determines the status of the devices that are queried for communication. For example, upon user U1 declaring network presence, address server 44 establishes an association between UID1 and its temporary address Add1. The status unit 39 may poll periodically the networked device 30 to ascertain if it is still connected to the network. If device 39 does not respond, the status unit 39 instructs the database to discard Add1 information. Other status checks may also be provided.

The address server could also be built as a separate application running on an existing intelligent platform and sharing the platform's resources with other applications. Platforms, such as computer servers, or networking routers can function as hosts for the address server application. For someone skilled in the art, it is evident that many other variations of the address server implementations are possible.

A networked device, such as device 30, 35 incorporates according to the invention, additional capabilities to complement and work in tandem with the address servers to provide a network-wide address discovery service, shown generically by an address query unit 33, 33′. The networked devices could be a computing platform including a CPU and memory, as shown by block 34, 34′ and various applications such as peer-to-peer service application B, shown at 3′, 3″. The networked device 30, 35 also has network communications capabilities, such as interface 27, 27′ with the address server 44, 45 and interface 29, 29′ with the peer networked device. Thus, device 30 communicates with the address server 44 over logical communications channel 37 and with the peer networked devices, such as 35, over logical communications channel 40. More precisely, address query unit 33 communicates with the address discovery unit 42 over logical communications channel 37 for transmitting its network address, originating queries to determine the addresses of other networked users and to receive and interpret the answer message received from the address server. Other information may also be exchanged between the address query unit 28 and address discovery unit 42, in the case of more complex applications. Channel 40 is used for peer-to-peer communication under control of application 3′.

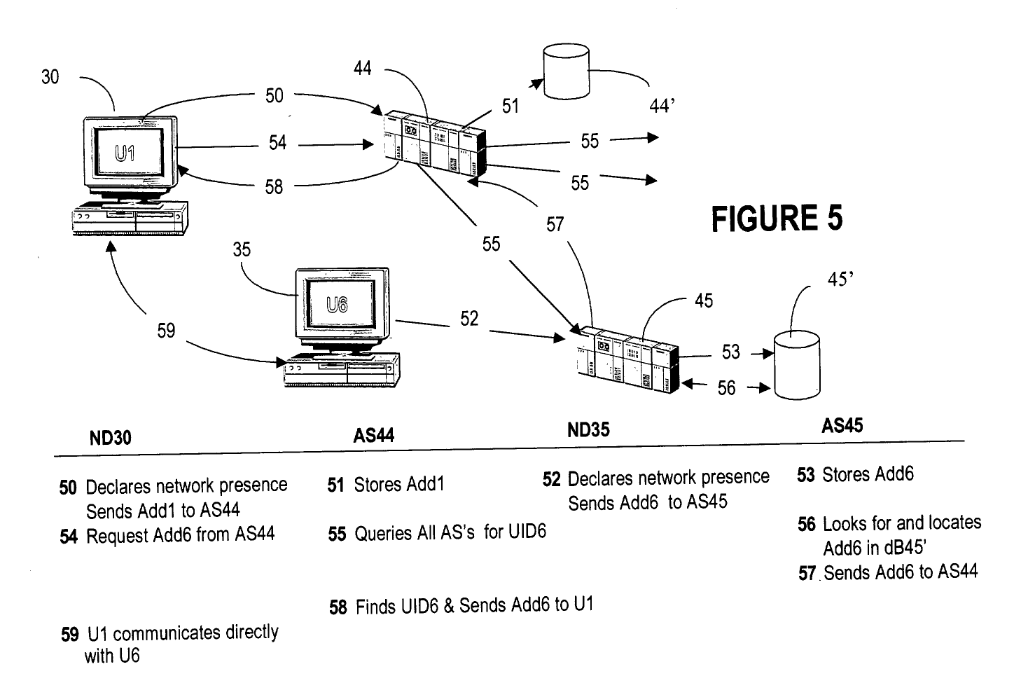

FIG. 5 shows the address discovery process used for enabling establishing peer-to-peer communication between users U1 and U6. Thus, when user U1 connects to the network through its network device 30, it sends its network address to the address server 44, as shown at 50. Address server 44 stores the network address Add1 of user 40 in database 44′, and establishes an association between the user identification UID1 and its address, step 51. We define this association as “address data”.

Suppose that another user U6 connects to the network and sends its network address to the address server 45, shown by steps 52. Address server 45 stores the network address Add6 of user U6 and establishes an association between the user identification and its address in the database, step 53. Let's assume that user U1 wants to establish a direct connection between its networked device 30 and user's U6 networked device 35. To determine the network address of user U6, user U1 initiates a request for information on user's U6 address and sends the request to address server 44, step 54. The term “address request signal” is used in the description and claims for this request.

Address server 44 receives the query and, in turn, interrogates the other address servers in the data network for user's U6 address information, step 55. This signal is called the “query signal” or “query ”. Address server 45 receives the query and searches its database 45′ for a match between the user identification from the query and the user identification stored in its database, step 56. If address server 45 finds UID6 in memory 44′, it responds to the query by sending the address information for user 41 to address server 44 as a “query response signal”, step 57. Address server 44 responds to the original query from user U1 by sending the network address for user U6 to user U1, step 58. Once U1 has the network address of U6, it may establish a direct connection with U6, as shown in step 59.

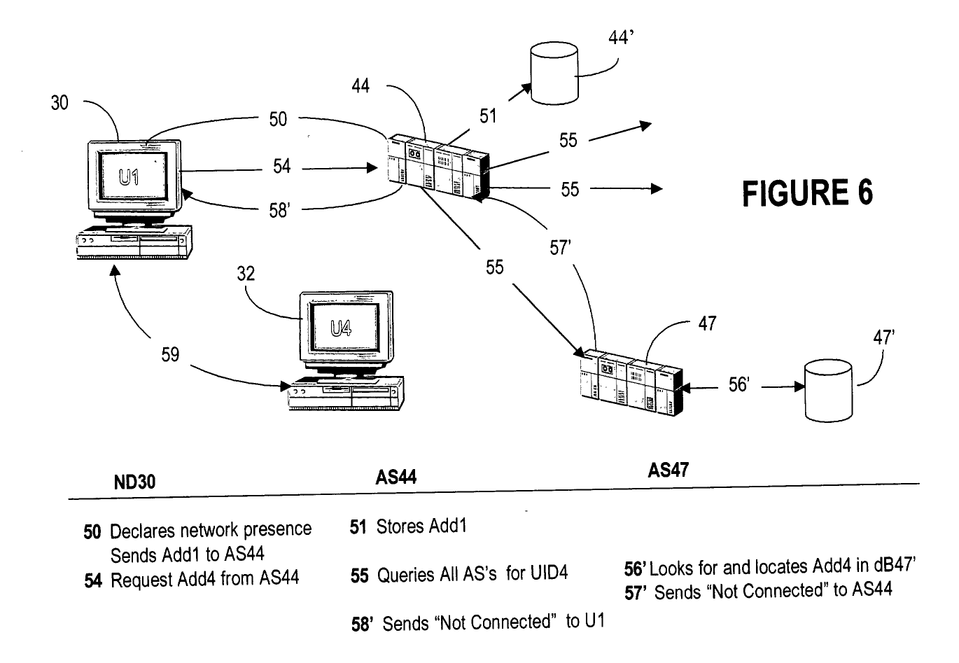

FIG. 6 shows the protocol used to obtain the address information of a device in another instance. Namely, let's say that U1 tries to establish a direct connection with U4, and U4 is not connected to the network at the time when user U1 attempts to establish communication. Steps 50-51 proceed as in the protocol described in connection with FIG. 5. When user U1 connects to the network through its network device 30, it sends its network address Add1 to the address server 44, which stores this network address and establishes an association between the user identification and its address in the database 44′. Since U4 is not connected to the network, steps 52 and 53 are not performed, so that network address of U4 is not stored at server 47. When U1 initiates a request for information on user's U4 address and sends the request to address server 44, step 54, address server 44 requests all the address servers in the data network to look for the user name of the user U4, step 55. Address server 47 checks its database 47′ and finds a match between the user identification of U4 from the query and the user identification stored in its database, in step 56′. However, address server 47 does not have a network address for user U4 since device 32 is not connected to the network. Address server 47 responds to the query by sending a “not connected” message to address server 44, step 57′. Address server 44 responds to the original query from user 40 by sending the “not connected” message to user U1, step 58′.

As discussed previously, the address servers and the networked devices incorporate capabilities to provide a network-wide address discovery service. Enhancements to the capabilities built into the address servers and the users' networked devices can provide additional functionality, allowing the user to exercise more control over the address discovery process. Thus, according to this invention, besides the address data (user identification-network address correspondence), the address servers may also maintain a user profile. The user profile may provide for example an association between the user identification and a user's password and various user instructions for the address server. These instructions could for example refer to handling requests for address information.

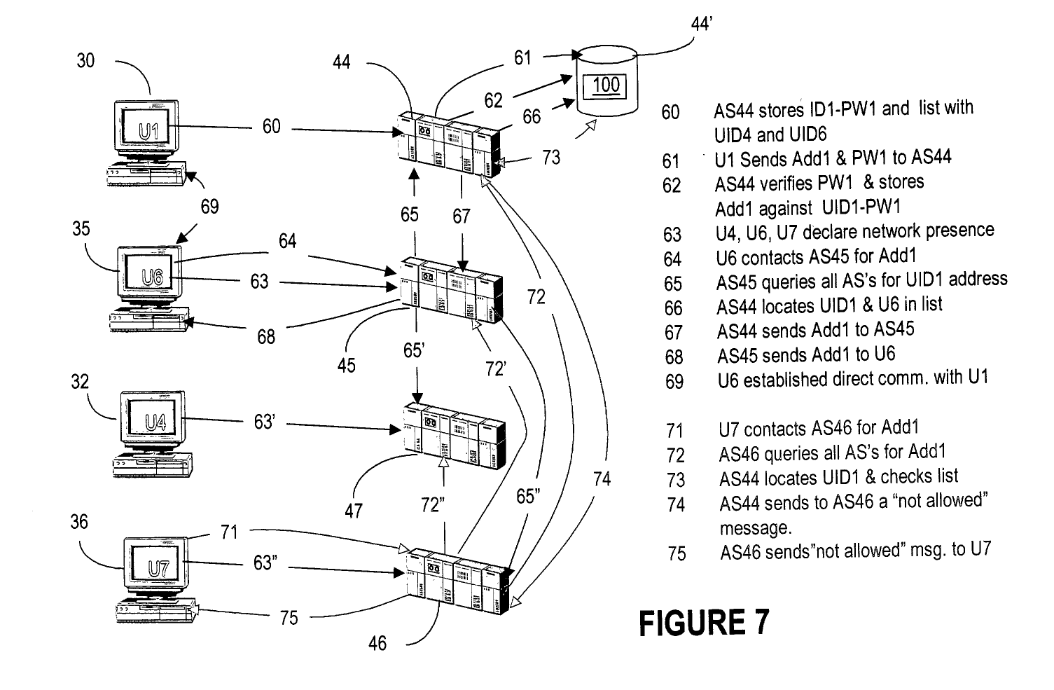

FIG. 7 illustrates such an example. Using the network shown in FIG. 4A, let's assume that user U1 wishes to allow users U6 and U4 to obtain its address information and that it does not wish to allow other users to obtain this information. In this case, database 44′ stores a list 100 including user U4 and user U6 identifications UID4 and UID6. Address server 44 stores in database 44′ the user identification UID1 and the password PW1 for U1, shown by step 60. Now, when user U1 logs-on the network through its network device 30, it sends its network address Add1 and its password PW1 to the address server 44, step 61. Address server 44 verifies user U1 password, and if correct, it stores the address data (network address Add1 against UID1) in the database 44′, as shown by step 62.

When users U4, U6 and U7 connect to the network, a similar log-on procedure verifies their password against the respective user name. If log-on is successful, the respective network addresses Add4, Add6 and Add7 are stored against the respective user identification UID4, UID6 and UID7 in the respective databases 47′, 45′ and 46′. This is shown in steps 63, 63′ and 63″. Let's now assume that user U6 wants to establish a direct connection between its networked device 35 and user's U1 networked device 30. To this end, U6 sends a request for Add1 to address server 45, step 64. Address server 45 receives the query and, in turn, interrogates the other address servers 44, 47 and 46 for user's U1 address information, step 65,65′ and 65″. Address server 44 receives the query, searches its database 44′ and finds a match between the user identification from the query and the user identification stored in its database, and also verifies user U6 identification presence in list 100, step 66. Next, address Server 44 responds to the query by sending Add1 to address server 45, step 67, which in turn sends Add1 to user U6, step 68. Now users U6 may send directly messages to user U1, as shown by step 69.

Let's say that user U7, whose user identification information UID7 is not on list 100, initiates a request for direct communication with U1. As before, it provides UID1 to address server 46 and requests Add1, step 71. Address server 46 receives the query and, in turn, interrogates the other address servers for UID7 address, step 72, 72′ and 72″. Address server 44 receives the query, searches its database 44′ and finds a match between the UID1 from the query and the UID1 stored in its database. Address server 44 also verifies if UID7 is in the list 100 with user U1 profile, and does not find it, step 73. As a result, address server 44 responds to the query by sending a “not allowed” message to address server 46, step 74. In turn, address server 46 responds to the original query from user U7 by sending the “not allowed” message to device 36, step 75.

It is to be mentioned that in the examples provided in FIG. 7, as well known, when a user does not provide the correct password, it cannot connect to the address server and use the address discovery process. For anyone skilled in the art, it is evident that variations of the user authentication process are possible, and also that the user profiles can have numerous other embodiments.

The address servers may also be provided with the capability of terminating the association established between a certain UID and Add (address data). This is necessary to ensure that the information contained in the address servers is accurate and current. The following conditions may trigger the address server to discard the address information associated with a user:

after a default time interval from the initial user's connection to the network,

after a time interval specified in the user's profile,

after receiving a termination request from the user,

after a time interval specified by the user when connecting to the network.

The address servers may be provided with additional capabilities. As was previously discussed, according to another embodiment of the invention, the address server may perform poling of the individual devices by sending a “connection active” query to ascertain if the respective connection is still active. When a user disconnects from the network, the address server does not receive a reply to the connection active query and proceeds to discard the user's address from its database.

For anyone skilled in the art, it is evident that other variations of the trigger for discarding the address are possible.

The actual implementation of the address discovery process dictates the level of control a user has over the dissemination of the address information. As previously discussed, a user can specify in its profile conditions that limit the accessibility of other users to its address information. In addition, a user may control the dissemination of the address information by instructing the address discovery unit to declare network presence automatically upon connecting to the network, initiate sending its address to the address server at its discretion following a user command, or preventing its address to be made available to other users by simply inhibiting the process that sends the address to the address server.

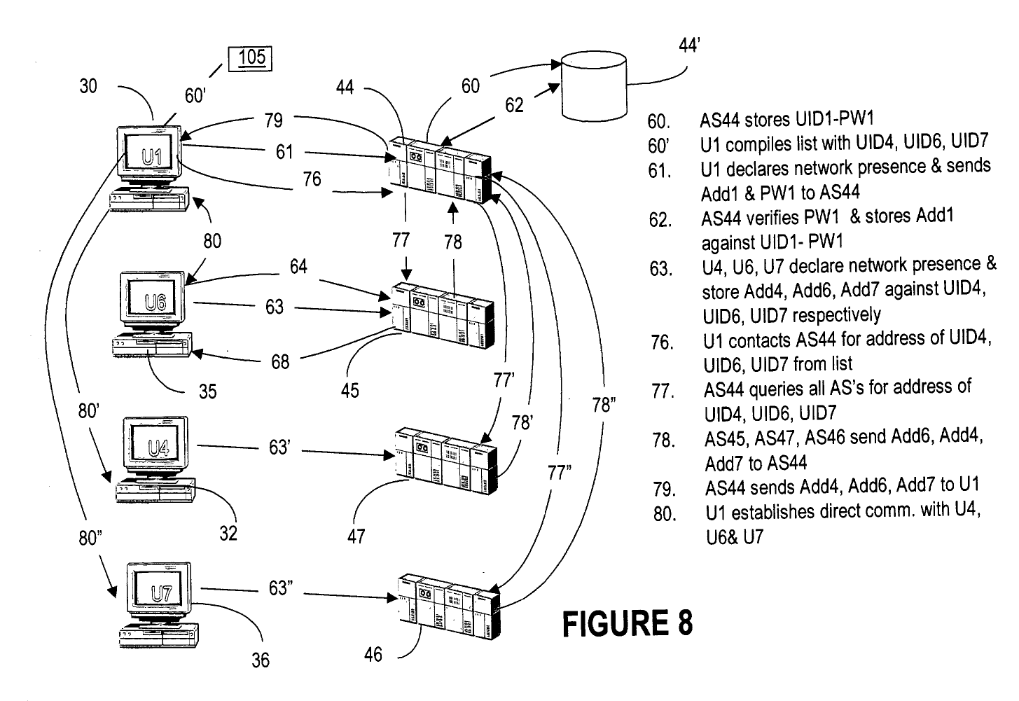

FIGS. 5, 6 and 7 provided examples of an address discovery process that allows one user to obtain the address information of another user connected to the network. FIG. 8 shows a protocol used to obtain the address information of a plurality of networked devices in still another instance, according to another aspect of this invention. Thus, a user U1 for example, may create and maintain on his networked device, a list of UIDs for the users with whom U1 interacts frequently. When user U1 wishes to find out the address information for several users on the list, instead of sending individual requests for each user, he can send a single request including a selection of names from his list. Let's say that, as shown in FIG. 8, user U1 connects frequently with users U4, U6 and U7 and other users, not shown. User U1 maintains a list 105 including the names of all these users, step 60′. As before, database 44′ also stores the UID1-PW1 correspondence, shown at step 60. When user U1 logs on, device 30 sends to address server 44 the user name UID1, the PW1 and Add1, step 61, so that the address server can verify the received UID1-PW1 against the pre-stored UID1 PW1, step 62. Let's say that users U4, U6 and U7 have also logged-on successfully, steps 63, 63′, 63″. Now, if user U1 wants to connect directly with users U4, U6 and U7, he/she selects from the list 105 UID4, UID6 and UID7 and sends an address request to the address server 44, step 76. Address server 44 receives the request and interrogates, as before, the other address servers 45, 46 and 47 for the users U4, U6 and U7 respective addresses, steps 77, 77′ and 77″. In response, as the UID6 for user U6 is stored by database 45′, address server 45 responds to the query by sending the address information for user U6 to address server 44, step 78. Following the same process, address servers 46 and 47 respond to the query by sending the address information for user U7 and respectively U6 to address server 44, steps 78′ and 78″.

Finally, address server 44 creates a response message including Add4, Add6 and Add7 and sends it to device 30, step 79. Now U1 may establish a direct connection with U4, U6 and U7, step 80, 80′ and 80″.

Note that the names of the users served by the same address server as the originator of the request are not included in a query. Also, when a user is not connected to the network, or when the profile of one of the queried users disallows address dissemination, the appropriate address server will send a reply to the query indicating the “not connected” status of the user, or a “not allowed” message.

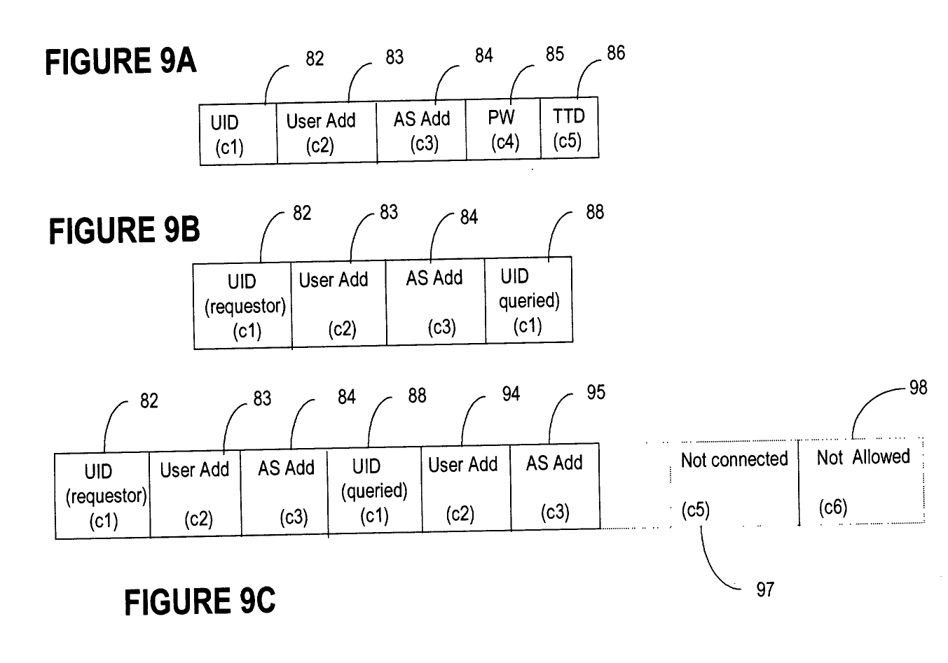

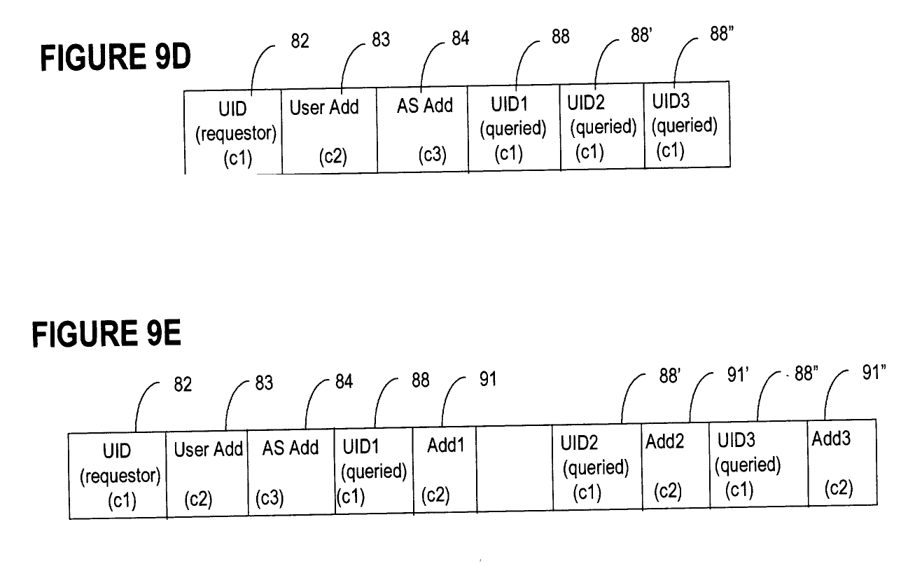

The address discovery process described in this invention is supported by a set of simple messages exchanged between the networked devices and the address servers and messages exchanged between the address servers. FIG. 9A to 9E show various examples of signaling message formats supporting this invention. The examples of signal formats are a simplified representation of the actual communications formats that are used in well-known, established protocols. The last row in each cell provides the length (number of characters) of the respective field. The intent of this invention is not to define new communications protocols, but only to expand the information fields in such protocols to ensure that the information required for implementing this invention's teachings is present.

Thus, FIG. 9A shows an example of a “network presence declaring” signal for logging on an address server following the connection of his device to the network. It includes a c1—character field 82 with the user name UID, a c2—character user's network address Add field 83 and a c3—character field 84 for the network address of the associated address server. As previously discussed, other fields 85, 86 may be required to transmit such information as user's password PW, time interval before discarding the address information, etc.

FIG. 9B shows an example of an “address discovery request” signal sent by a networked device requesting the address of another networked device. In its simpler form, the following information fields are included: the UID of the requestor field 82, user's Add, field 83, the network address of the associated address server, field 84 and the UID of the user whose address is requested, field 88. Note that the same information is required when the address server sends the request to the other address servers, namely the query signal.

FIG. 9C illustrates an example of the format of a “query response” signal sent be the address server to the requestor. It also exemplifies the format of a query response signal when the requested user address is not available. In its simpler form, the following information fields may be included: the UID of the requester field 82, its network address Add, field 83, the network address of the associated address server, field 84, the UID of the user whose address information is required, field 88, its network address, field 94, and the network address of the address server responding to the query, field 95. When the user whose address information is required is not connected to the network, or when the user requesting the address is not allowed to access this information, the network address field 94 is omitted and a message field 97 or 98 is inserted indicating the “not connected” status of the user, or “not allowed”, respectively. Note that the same information is necessary when the address server receives the response from the queried address servers (i.e. the query response signal). For anyone skilled in the art, it is obvious that other variations of the signal structure are possible to implement the teachings of this invention.

FIG. 9D shows a multiple address request signal for an n-way conference for example. In its simpler form, the following information fields are included: a unique user name or identification of the requestor field 82, user's network address filed 83, the network address field 84 of the associated address server, and the names or identifications of the other users for which the address information is required 88, 88′ and 88″. Note again that the same format may be used when the address server sends the request to the other address servers.

FIG. 9E shows an example of a multiple query response signal for an n-way direct communication sent by the address server responding to a multiple address request signal. In its simpler form, the following information fields are included: a unique user name or identification of the requestor 82, user's network address 83 and the network address of the designated address server, field 84. Also, this signal includes the name or identification of the queried devices, fields 88, 88′, 88″ and their respective address information, fields 91, 91′ and 91″. As mentioned in a previous example, the queried user address field may be replaced with a message, such as “Not Connected” or “Not Allowed” when the queried user's address is not available.

I claim:

1. A method of address discovery in a data network connecting a plurality of networked devices, comprising:
providing at least a first and a second address servers for serving a first and a second networked device respectively; and
declaring network presence by said first networked device upon connection to said first address server, by transmitting to said first address server a first address data.

2. A method as claimed in claim 1, wherein said first address data comprises a current network address of said first networked device Addr1 and a user identification for a current user of said first networked device UID1.

3. A method as claimed in claim 2, further comprising transmitting an address discovery request signal from said first networked device to said first address server specifying a user identification UID2 of said second networked device.

4. A method as claimed in claim 3, further comprising broadcasting said address discovery request from said first address server to all other address servers in said data network.

5. A method as claimed in claim 4, further comprising, at said second address server, detecting said UID2 and transmitting a query response signal from said second address server to said first address server.

6. A method as claimed in claim 5, wherein said query response signal includes the current network address Addr2 of said second networked device whenever said second networked device is connected to said second address server.

7. A method as claimed in claim 5, wherein said query response signal includes the current network address Addr2 of said second networked device whenever said second networked device is connected to said second address server and whenever a user profile associated with said UID2 allows access to said Addr2.

8. A method as claimed in claim 5 further comprising transmitting said query response to said first networked device from said first address server.

9. A method as claimed in claim 8, further comprising establishing a direct connection between said first and said second networked devices based on said Addr1 and Addr2.

10. In a data network connecting a plurality of networked devices, a method for establishing a direct connection between a first networked device and a second network device, each provided with a compatible peer-to-peer application, comprising:
providing a first address server for updating a first address data whenever said first networked device connects to said network;
providing a second address server for updating a second address data whenever said second networked device connects to said network; and
transmitting said first address from said second address server to said first address server on request.

11. A method as claimed in claim 10, further comprising discarding said address data after a specified time interval.

12. A method as claimed in claim 11, wherein said time interval is a network specified value.

13. A method as claimed in claim 11, wherein said time interval is a user specified value.

14. A method as claimed in claim 10, further comprising verifying the network presence of said networked devices and discarding said address data accordingly.

15. In a data network with a first networked device having a first current address Add1 and a second networked device having a second current address Add2, a method of direct communication between said first and said second networked device comprising:
(a) providing a first address server with a first address data for said first networked device and providing a second address server with a second address data for said second networked device;
(b) at said first networked device, requesting from said first address server said Add2;
(c) at said first address server, obtaining said Add2 from said second address server and transmitting same to said first networked device; and
(d) establishing a direct communication between said first and said second device based on said first and second current address data.

16. A method as claimed in claim 15, wherein said second address data comprises said second address Add2 and a second identification UID2 of said second networked device.

17. A method as claimed in claim 16, wherein said step (c) comprises:
querying said second address server for said UID2;
detecting said UID2 at said second address server; and
transmitting said Add2 data from said second address server to said first address server.

18. A method as claimed in claim 16, wherein said second address data further comprises a message field for transmitting to said first address server a message regarding the status of said second networked device.

19. A method as claimed in claim 18, wherein said message field indicates that said second networked device is not currently connected.

20. A method as claimed in claim 18, wherein said message field indicates that said second networked device does not allow transfer of said second address to said first address server.

21. A method as claimed in claim 16, further comprising providing said first address server with a list L(UID) with a plurality of user identifications that are allowed to obtain said Add1.

22. A method as claimed in claim 17, wherein said step (b) comprises transmitting an address request signal to said first address server, including said first address data and said UID2.

23. A method as claimed in claim 16, wherein said step (b) comprises transmitting an address request signal to said first address server, including said first address data and a plurality of user identifications including said UID2.

24. A method as claimed in claim 16, wherein said first address data further comprises a first password for authentication of said first user.

25. A method as claimed in claim 15, further discarding said respective first address data and second address data after a time-to-discard.

26. A method as claimed in claim 25, wherein said time-to-discard data is provided in one of said address data, a user profile and a user request.

27. In a data network, an address server comprising:
an address discovery unit for determining a temporary network address;
a network interface for providing an address request signal to said address discovery unit and transmitting said network address from said address discovery unit;
an address server interface for broadcasting a query signal and receiving a query response signal; and
a processing unit for controlling the operation of said address discovery unit, said networked device interface and said address server interface.

28. An address server as claimed in claim 27, further comprising a database for maintaining current address data for a plurality of networked devices.

29. An address server as claimed in claim 28, wherein said address data comprises a temporary network address of a networked device that declares network presence to said address server and an user identification provided by said networked device.

30. An address server as claimed in claim 29, further comprising an authentication unit for password verification based on a password prestored against said user identification.

31. An address server as claimed in claim 30, further comprising a status verification unit for determining the status of said networking device.

32. In a data network, a networked device having a first network address Add1, comprising:
an address query unit for declaring network presence and requesting a second network address Add2 of a queried networked device;
an interface for transmitting an address request signal and receiving said Add2;
a peer-to-peer service application for providing a certain service; and
an interface for enabling said network devices to communicate directly to each other based on said Add1 and Add2 to implement said service; and
a processing unit for controlling the operation of said address query unit, respective said interfaces and said service application.
